(19) United States
(12) Patent Application Publication
(10) Pub. No.: US 2012/0017841 A1
(43) Pub. Date: Jan. 26, 2012

(54) Automatic animal door and a method of containing birds

(76) Inventors: Antonije Andric, Lockhart, TX (US); Mark Allen George, Lockhart, TX (US)

(21) Appl. No.: 12/804,577

(22) Filed: Jul. 24, 2010

(51) Int. Cl. A01K 1/00; E05F 15/20; E06B 3/36

(52) U.S. Cl. 119/416; 49/399; 49/28; 49/29

(57) ABSTRACT

An automatic animal door having a door for closing off an entrance and a controls unit, the door having a vertical axis, a top, and a bottom, comprises means for rotating the door about a vertical axis. It is desired that the automatic animal door of the present invention rotates the door at preset times as follows: door opening at sunrise, door closing at sunset, door opening a short time thereafter, and door closing a final time in a 24 hour cycle a short time thereafter. A method of controlling the containment of birds using an automatic animal door, the automatic animal door having a door for closing off an entrance and a controls unit, comprises the step of automatically rotating the door about a vertical axis, preferably multiple times in a 24 hour period.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING

Not Applicable

### BACKGROUND

With the recent focus on natural food sources, it has become more common for consumers to own a number of chickens for personal consumption or sale on a small scale basis.

Chickens are known for their roosting instinct, a habit in which chickens generally, as a group, return to a housing structure or coop for the night.

Many animals prey upon chickens, birds, and other poultry; these predators include skunks, owls, raccoons, hawks, opossums, bobcats, and dogs, with raccoons being the most agile and persistent of these predators. In the case of poultry, it is common for homeowners to install automatic poultry doors that close automatically at night, thus preventing predators from entering the coop, and open each morning to allow the poultry to roam throughout the day.

Generally, poultry doors open vertically in a sliding motion, and have a number of shortcomings.

For example, as shown in FIG. 1, poultry doors that open vertically generally utilize a pull-string 32 to pull the door 34 up a guide frame 33. To open and close the door 34, an actuator 30 winds or unwinds the string 32 around an axial arm or pulley 31 located above the door 34. During this activity, the string 32 commonly becomes entangled. Further, it is known that animals, such as raccoons in particular, have the ability and are intelligent enough to pull the string 32, which is often located on the exterior of the door 34, to open the door 34 and access to the poultry inside. Where the string 32 is located inside the coop, chickens are known to disrupt the pull function by pecking at the string 32, thus causing the door 34 to become permanently lodged in an undesirable position. It is further known that, in both cases, that tracks upon which the vertical sliding doors slide become soiled and/or eroded, thus causing the door to become wedged in a partially open position. String breakage from age is another common malfunction of such doors, causing poultry or birds to be locked inside the coop.

An alternative door known in the industry, and shown in FIGS. 2a and 2b, essentially comprises the same or similar pull string 42 and linear actuator mechanism 41. In this alternative door, however, the pull string 42 is attached to a lower portion of the door 44, and, during the opening motion, causes the door 44 to rotate about a horizontal axis 43 at the top of the door 44 towards the wall 40 of the coop. In this situation as well, raccoons can and do simply raise the door 44 up by pulling up on the string 42. Weasels also are known to pull on the string 42 to open the door 44. This alternative door cannot be installed with the pull string 42 on the inside of the structure, as it would then allow predators to simply push the door open.

Further, in both of the above cases, switches are used to set open/close time limits. These switches have a high failure rate in the soiled and extreme environment of a chicken coop.

Another problem associated with the poultry doors of the prior art, shown in FIGS. 1, 2a, and 2b, is that, due to the vertical requirements for equipment or hardware, the height of the associated chicken coop must be significant, as much as three feet.

In the case of wild or pet birds being housed, it is not common to install any type of door on the housing structure. That is, the structure, usually located far above the ground, is open throughout the night, thus allowing nocturnal predators with the ability to climb to enter at will. It is desirable to install a door that closes at night to protect these birds, particularly endangered birds, from predators.

For at least these reasons, there thus remains a need for an automatic animal door that will reliably prevent predators from obtaining access to animals contained inside a structure.

### SUMMARY

The present invention is an automatic animal door having a door for closing off an entrance and a controls unit, the door having a vertical axis, a top, and a bottom, wherein the automatic animal door comprises means for rotating the door about a vertical axis.

The automatic animal door of the present invention preferably comprises means for sensing a position of the door, and means for sensing an obstruction of the entrance to be closed, and the controls unit preferably comprises means for rotating the door to an open position based on a sensing of an obstruction of the entrance prior to exerting more than a predetermined force upon the obstruction.

It is desired that the automatic animal door of the present invention rotates the door at preset times as follows: door opening at sunrise, door closing at sunset, door opening a short time thereafter, and door closing a final time in a 24 hour cycle a short time thereafter.

The automatic animal door may comprise a frame and means for maintaining the door in a closed position such that a predetermined force or more is required to manually open the door.

The present invention also relates to a method of controlling the containment of birds using an automatic animal door, the automatic animal door having a door for closing off an entrance and a controls unit, wherein the method comprises the step of automatically rotating the door about a vertical axis, preferably multiple times in a 24 hour period.

The method of the present invention may include the steps of programming the controls unit to open the door a desired angle at a desired time by holding a magnet near the controls unit, and programming the controls unit to close the door at a desired time by holding a magnet near the controls unit.

The method of the present invention preferably includes the steps of opening the door approximately at sunrise, closing the door approximately at sunset, opening the door approximately 20 seconds to 2 minutes after sunset, and closing the door approximately 10 seconds to 1 minute after the most recent opening.

The method also preferably includes the steps of opening the door upon a sensing of an obstruction of the door, prior to exerting more than a predetermined force upon the obstruction, and closing the door.

The method of the present invention also preferably comprises the step of closing the door by holding a magnet near the controls unit.

### BRIEF DESCRIPTION OF THE DRAWINGS

FIG. 1 is a front view of a poultry door according to the prior art.

FIG. 2a is a side view of another poultry door according to the prior art in the open position.

FIG. 2b is a side view of the poultry door of 2a in the closed position.

FIG. 3 is a front view of one embodiment of the present invention with an optional frame, in the closed position.

FIG. 4 is a detail of a pivot point of the animal door of the present invention with an optional frame.

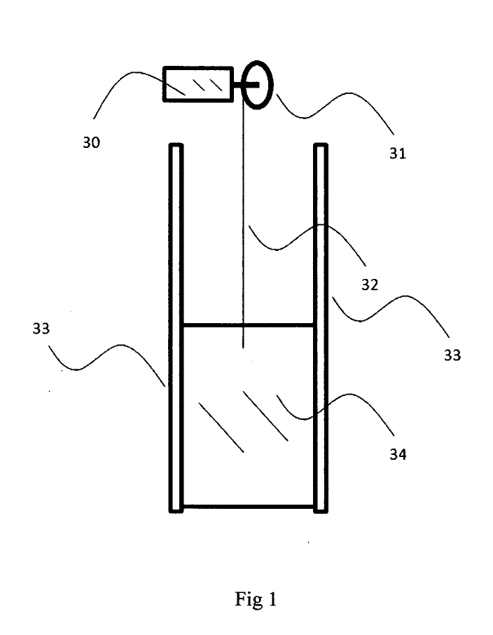

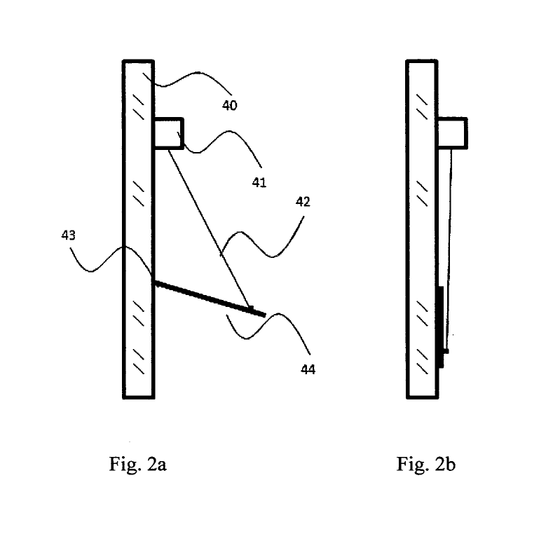

### DESCRIPTION

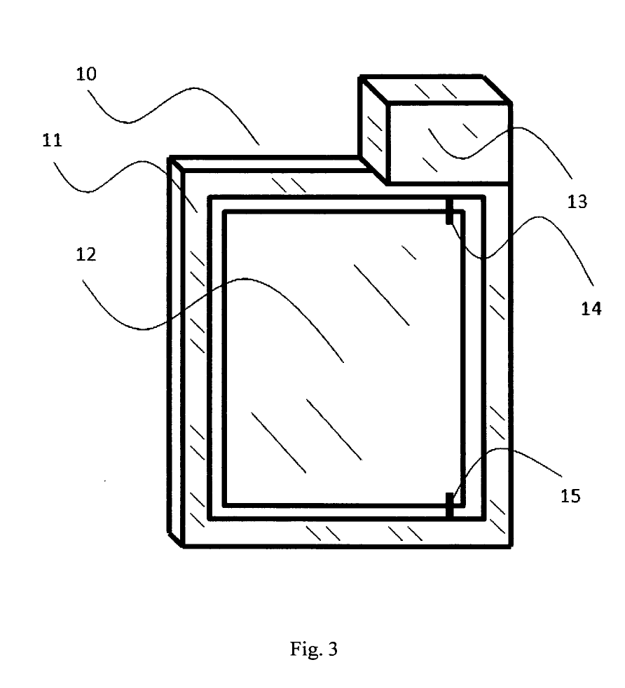

Referring now to FIG. 3, the object of the present invention is described in further detail. The automatic animal door 10 is shown with an optional frame 11, door 12, controls unit 13, top pivot point 14, and bottom pivot point 15.

For the purpose of this application, the term “top” shall refer to that location that would be above the head of a hypothetical animal or bird walking through the door 12 when the door 12 is installed in a containment structure or coop. That is, even in a disassembled position, such as packaged for shipment, the term “top” shall be understood to be associated with the intended top after installation.

Similarly, the term “bottom” shall refer to that location that would be under the foot of a hypothetical animal or bird walking through the door 12 when the door 12 is installed in a containment structure, and the terms “vertical” or “vertical axis” shall refer to that direction associated with a line drawn normal to the top and bottom of the door 12.

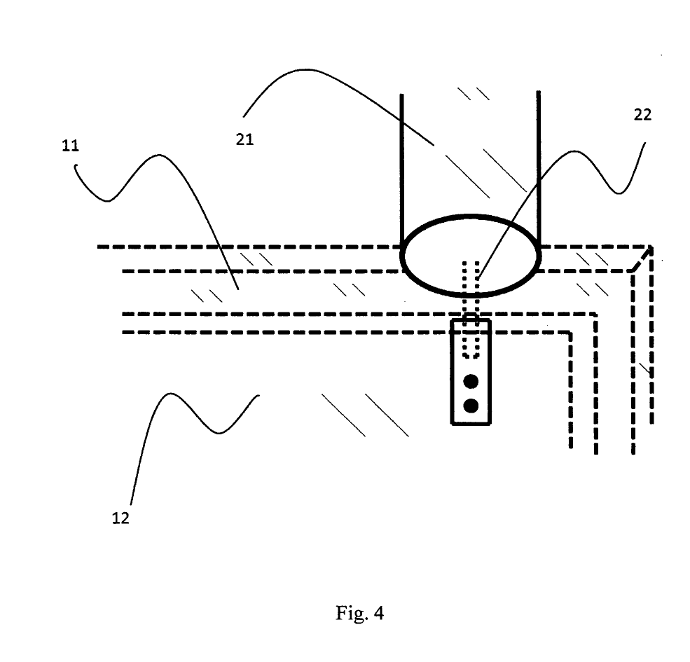

Continuing with FIG. 3 and FIG. 4, the automatic animal door 10 of the present invention comprises a controls unit 13 and a door 12. The controls unit 13 includes a timing mechanism that can be programmed and adjusted to control the operation of the door, and a motor 21.

A shaft 22 connects the motor 21 to a top pivot point 14.

When the motor 21 is activated, the door 12 is rotated about a vertical axis associated with a line drawn between the top pivot point 14 and the bottom pivot point 15.

The combination of this direct motor 21 to shall 22 engagement and vertical rotation effectively ensures that predators, such as raccoons, cannot obtain access to prey inside when the door is in a closed position, due to the elimination of pull strings such as those associated with the prior art, as well as the ability to control the force required to manually override the door. In the case of chickens or similar birds, a predetermined force to maintain the door 12 in a closed position is preferably about 18 kg-f (39.68 lb-f). This force is enough to prevent raccoons from opening the door because, although raccoons may pull as much as 13 kg-f (28.66 lb-f), they do not have the leverage in the needed position to reach their maximum strength. When the automatic animal door 10 is used to contain birds located in a high housing, it is thought that a lighter force to manually open may suffice, which in turn means a lighter-duty gear mechanism or other torque limiter known in the industry may be used.

Another advantage obtained by the use of a door 12 rotating about a vertical axis is the reduction in height that is required for the chicken coop or containment structure. Many owners utilize small coops, and, the present invention is compatible with small coops. When used to contain chickens or similar birds, the automatic animal door 10 is preferably approximately 43 cm (17 in) tall and 33 cm (13 in) wide, which is large enough to allow birds access without requiring a large entrance cut in the coop, although it will be understood by those skilled in the art that other sizes are possible. It will also be understood by those skilled in the art that it is not necessary that the door 12 be of a rectangular or square form. Other shapes, such as ovular or circular are possible and contemplated for smaller birds in particular, as long as a vertical axis of rotation can be achieved in a stable manner.

Another preferred feature of the present invention includes the ability of the controls unit 13 to control the angle or distance of the opening of the door 12. The controls unit 13 can be programmed to open the door 12 at a small angle to allow, for example, nothing larger than a chicken to enter, or at a large angle, to perhaps allow a duck to enter the coop.

It is also preferred that the controls unit 13 be set to control the opening and closing of the door 12 as follows: door 12 open at approximately sunrise, door 12 close at approximately sunset. A short time later, the door 12 should open a second time to allow late chickens or other birds to enter. The door 12 should close a final time shortly thereafter. This “second chance” opening is very effective in ensuring that all birds enter the building, as the animals have a visual reminder of the pending nightly closure with the door 12 closing the first time, as well as a chance to enter quickly if they are late or part of a large group entering the coop.

Ideally, the door 12 is set to open around 1 minute after closing at sunset, although other times are contemplated by the inventor, currently between 20 seconds and 2 minutes. Larger groups, for example, may require more time. The door 12 should remain open for approximately 10 seconds to 1 minute before closing a final time for the night; again, however, it is contemplated by the inventor that this time may be adjusted.

It will be understood by those in the industry that the controls unit 13 should be programmable by the end user to allow for an adjustment for winter/summer daylight hours, as well as for time zone changes. This can be achieved in a number of ways by those skilled in the art.

Another preferred feature of the present invention is the ability to detect an obstruction of the entrance. Poultry doors of the prior art have been known to close with an animal stuck in the entrance, thus causing damage to the animal or trapping it in the entrance for an entire night, where it is at risk of attack by predators. The automatic animal door 10 of the present invention preferably includes a sensor (not shown) within the controls unit 13 that may detect that an object is blocking the door 12 from closing completely. It will be understood by those skilled in the art that any number of sensors may be used for this purpose, including, but not limited to, position, angle, displacement, and pressure or force, as long as the chosen sensor is suitable for the purpose of determining if an entrance is blocked.

When the animals being contained are chickens, the controls unit 13 is ideally set to open the door 12 prior to exerting more than 2.25 kg-f (4.96 lb-f) upon an object blocking the entrance. This predetermined force is thought by the inventor to be uncomfortable enough to give a chicken incentive to stay out of the entrance, but not injure the animal. Adult chickens weigh approximately 2.25 kg (4.96 lb). It will be understood by those skilled in the art that other predetermined forces may be desirable in various situations. Larger poultry, such as ducks, may be comfortable with or even require a greater force for such incentive, while small chicks or birds will require a much smaller predetermined force, perhaps 0.125 kg-f (0.275 lb-f).

Another preferred feature of the present invention is that the controls unit 13 should include the use of a reed switch (not shown). It has been known that standard switches utilized by automatic poultry doors according to the prior art degrade quickly in the soiled and extreme environment of a bird coop. By utilizing a reed switch, in which direct electronic contact is not required to initiate action, the environment is less of a factor in the reliability of the automatic animal door 10 of the present invention.

In a best mode embodiment, the automatic animal door 10 is delivered to an end user with an optional frame 11, controls unit 13, door 12, top pivot point 14, bottom pivot point 15, and magnet (not shown). In this best mode embodiment, the controls unit 13 includes a magnetic sensor or reed switch. After the end user installs the automatic animal door 10 and applies power, the automatic animal door 10 can be programmed and used in a manner which will be described in greater detail in subsequent pages of this application.

It will be understood by those skilled in the art that the materials used to construct the automatic animal door 10 of the present invention should be chosen with respect to the environment in which the invention will be placed. Any combination of plastics, metals, or even wood may be utilized, as long as they will not quickly degrade in the elements or under extreme and repetitive use. Metals are contemplated as the most reliable material under long-term use, as friction between moving parts and wear are minimal.

The present invention also relates to a method of controlling the containment of birds using an automatic animal door 10 having a door 12 for closing off an entrance and a controls unit 13, wherein the method comprises the step of rotating the door 12 about a vertical axis, preferably multiple times in a 24 hour period. This multiple rotation action provides greater flexibility in allowing birds to enter as late arrivals, or to control the opening or closing of the door 12 when an object blocks the entrance.

The method of controlling the containment of birds preferably comprises the steps of automatically opening the door 12 at approximately sunrise, closing the door 12 at approximately sunset, opening the door 12 a second time a short time later, perhaps approximately 1 minute, and closing the door 12 a final time shortly after the second opening, perhaps 30 seconds later.

The method of controlling the containment of birds also preferably includes the step of programming the controls unit 13 after installation of the assembly on a coop or containment structure.

This programming step is preferably achieved by holding a magnet (not shown) near the controls unit 13. Holding the magnet in front of the controls unit 13 is desired for two purposes: first, to set an angle of opening of the door 12, and second, to set desired opening and closing times. To set the opening time and opening distance, on the first day, the user should hold the magnet in front of the controls unit 13 until the door 12 opens to a desired position. The controls unit 13 is programmed during manufacture to retain this information for future use, and the controls unit 13 will open the door every 24 hours at the opening angle set by the user. The controls unit 13 will maintain the door 12 in an open position until the user programs a closing time. To set a closing time, the user should, on the first day as well, hold the magnet in front of the controls unit a second time. The controls unit 13 will close the door for the night, and will close the door ever 24 hours at the time set by the user.

At the time of manufacture, the automatic animal door 10 is preferably programmed to include a “second chance” closure. Each evening, after the closure time set by the user, the controls unit 13 should initiate another opening and closing cycle. The best mode currently contemplated by the inventor is an opening initiated approximately 1 minute after closure and a closure shortly thereafter, perhaps approximately 30 seconds. This, however, may be adjusted as needed.

Another preferred step in the method of containing birds is the step of closing the door at times other than those set by the user and manufacture. Specifically, in the case in which it begins to rain, or for some other reason it is desired to contain the birds, the method should include the step of closing the automatic animal door 10 by holding a magnet in front of the controls unit 13. The controls unit 13 is set at the time of manufacture to not interpret this step as a re-programming. The regular 24 hour cycle of opening and closing, plus the second chance closing, is maintained by the controls unit 13.

It is also preferred that the controls unit 13 comprise a torque limiter, of any type known to those skilled in the art. That is, the controls unit shall not, in the course of closing, exert more than a predetermined force upon an obstruction in the entrance. The controls unit 13 should, upon the sensing of an obstruction, open the door 12, hold for a time, and again attempt to close the door 12. The predetermined force should be determined based on the type of animal to be constrained. When the animal being contained is a chicken, for example, the maximum desired force is around 2.25 kg-f (4.96 lb-f), while a small bird should experience no more than 0.125 kg-f (0.25 lb-f). This may be repeated a number of times. It is also preferable to set, at manufacture, a limited number of attempted closures.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the claims.

What is claimed is:

1. An automatic animal door having a door for closing off an entrance and a controls unit, the door having a vertical axis, a top, and a bottom, wherein the automatic animal door comprises:
means for rotating the door about a vertical axis.

2. The automatic animal door of claim 1, further comprising:
means for sensing a position of the door.

3. The automatic animal door of claim 1, further comprising:
means for sensing an obstruction of the entrance to be closed, and
the controls unit comprises means for rotating the door to an open position based on a sensing of an obstruction of the entrance.

4. The automatic animal door of claim 3, wherein:
the controls unit comprises means for rotating the door to an open position prior to exerting more than a predetermined force upon the obstruction.

5. The automatic animal door of claim 3, wherein:
the controls unit comprises means for rotating the door to an open position prior to exerting more than 2.25 kg-f (4.96 lb-f) upon the obstruction.

6. The automatic animal door of claim 1, further comprising:
a reed switch.

7. The automatic animal door of claim 1, wherein:
the controls unit comprises means for controlling a rotation of the door multiple times in a 24 hour timeframe at preset times.

8. The automatic animal door of claim 7, wherein:
the rotation of the door at preset times is approximately as follows:
door opening,
door closing approximately 4 to 20 hours thereafter,
door opening again approximately 20 seconds to 2 minutes thereafter,
door closing again approximately 30 seconds thereafter, and
door remaining closed for the remainder of a 24 hour cycle.

9. The automatic animal door of claim 1, wherein:
the controls unit comprises means for rotating the door multiple times in a 24 hour timeframe based on a timed setting.

10. The automatic animal door of claim 9, wherein:
the door is rotated on a timed setting approximately as follows:
door opening at sunrise,
door closing at sunset,
door opening again approximately 20 seconds to 2 minutes after sunset, and
door closing again approximately 30 seconds after opening.

11. The automatic animal door of claim 1, wherein:
the automatic animal door further comprises a frame, and
means for maintaining the door in a closed position such that a predetermined force or more is required to manually open the door.

12. The automatic animal door of claim 1, wherein:
the controls unit comprises means to control an open angle of the door.

13. A method of controlling the containment of birds using an automatic animal door, the automatic animal door having a door for closing off an entrance and a controls unit, wherein the method comprises the step of:
automatically rotating the door about a vertical axis.

14. The method of claim 13, wherein the door is rotated multiple times in a 24 hour period.

15. The method of claim 14, further comprising the steps of:
programming the controls unit to open the door a desired angle at a desired time by holding a magnet near the controls unit, and
programming the controls unit to close the door at a desired time by holding a magnet near the controls unit.

16. The method of claim 14, further comprising the steps of:
opening the door approximately at sunrise,
closing the door approximately at sunset,
opening the door approximately 20 seconds to 2 minutes after sunset,
closing the door approximately 30 seconds after the most recent opening.

17. The method of claim 14, further comprising the steps of:
opening the door,
closing the door approximately 4 to 20 hours thereafter,
opening the door approximately 20 seconds to 2 minutes thereafter,
closing the door approximately 30 seconds thereafter, and
door remaining closed for the remainder of a 24 hour cycle.

18. The method of claim 13, further comprising the steps of
opening the door upon a sensing of an obstruction of the door, and
closing the door.

19. The method of claim 18, wherein the door is opened prior to exerting more than a predetermined force upon the obstruction.

20. The method of claim 13 further comprising the step of:
manually opening the door by exerting not less than a predetermined force upon the door.

21. The method of claim 13, further comprising the step of:
maintaining the door in a closed position absent both an input from the controls unit indicating the door should open and an opening force that is greater than a predetermined force upon the door.

22. The method of claim 13, further comprising the step of:
closing the door by holding a magnet near the controls unit.
